(19) United States
(12) Patent Application Publication
(10) Pub. No.: US 2008/0316043 A1
(43) Pub. Date: Dec. 25, 2008

(54) Endangered child warning system

(76) Inventor: Richard Gomes, Coulterville, CA (US)

Correspondence Address: Richard M. Gomes, 7312 Dogtown Rd., Coulterville, CA, 95311, US

(21) Appl. No.: 11/821,510

(22) Filed: Jun. 25, 2007

(51) Int. Cl. G08B 21/02

(52) U.S. Cl. 340/686.6

(57) ABSTRACT

An endangered child warning system that has a flat, soft pad deformable to fit beneath a small child in a child car seat, or other structure, such as a bassinet, child bed, stroller, or the like and a distance monitor removably secured to the pad during cleaning of the pad and a remote alarm having an audio alarm removably secured to the distance monitor whereby moving of the remote alarm to a pre-set distance from the distance monitor will actuate said audio alarm, and with the system further having a quick coupler between the remote alarm and a key chain for a vehicle key.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

### Field of the Invention

This invention relates to systems for protecting children, i.e., babies, toddlers, and pre-school children, particularly, from being left unattended in unsafe conditions.

Every year there are many young children that are left by adult caretakers in unsafe conditions. Usually, the child is placed in such an unsafe condition, inadvertently, or is left in such condition and then forgotten, even for short time periods by the adult responsible for the child.

It is all too common, for example, that an adult will place a small child in a car bed, or child safety chair properly secured in an automobile and that the adult responsible for such child will then leave the automobile while attending to some other business or activity, other than taking care of the child. If the vehicle, with the child inside, is left in the sun, even with the windows open, or partially opened, or even more dangerously with the windows closed, the child's health can be quickly adversely affected.

Also, it is not uncommon that an adult responsible for a child leaves the child in a vehicle, while the adult simply goes into a store or shop to pickup some items, or returns to a house to pickup a forgotten item, before returning to the vehicle. Once again, with the adult gone, the child is subject to becoming overheated in the vehicle, or to being kidnapped if the vehicle is stolen while the adult is attending to other activities.

There have also been many instances of adults responsible for children secured in a stroller leaving a child for a brief period of time and another person wheeling the stroller and baby away.

### BRIEF SUMMARY OF THE INVENTION

### OBJECTS OF THE INVENTION

Principal objects of the present invention are to provide a system that will allow constant monitoring of the distance between a child and a responsible adult.

It is a further object to provide a remote alarm for warning the responsible adult and other persons in the vicinity, in the event the distance between the adult and the child exceeds a pre-set distance.

Still another object of the invention is to provide an audio warning system that requires the responsible adult to return to the child in order to silence the audio alert.

Another object is to provide an alert system wherein a distance monitor component of the alert system that remains in place with a child left by a responsible adult will sound an alert at the same time a mobile warning alert carried by the responsible person simultaneously sounds an alert.

Yet another object is to provide a monitoring system that is readily moved from one child location and restraint system to another child location and restraint system.

Other objects are to provide a monitoring system that provides comfort to a small child using a soft pad that is easily cleaned to protect the health of children with whom it is used.

### FEATURES OF THE INVENTION

Principal features of the invention include a soft flexible pad that is easily moved from, and used with any child restraint system, i.e., a child's bed, safely belted into a vehicle and/or a child's safety seat secured in a vehicle, or baby stroller. A monitor unit having a distance monitor and a remote alarm is removably secured to the pad. A quick connect coupler receiver is secured to a remote alarm and a mating quick connect complier is secured to a vehicle key chain, or other device normally carried by an adult responsible for a child.

The pad is of a soft, blanket material that will provide comfort to a small child coming in contact with the pad, and is easily washed in a washing machine as necessary to maintain it clean and sanitary. The monitor unit is removed from the pad prior to washing of the pad.

Additional objects and features of the invention will become apparent to those skilled in the art to which the invention pertains from the following detailed description, drawings and claims.

### THE DRAWINGS

In the Drawings

FIG. 1 is an exploded perspective view of the monitor unit of the invention, arranged for positioning in a conventional baby car seat;

FIG. 2, a perspective view of the monitor unit of the invention, as used in a conventional car baby seat, and with a baby strapped into the seat;

FIG. 3, an enlarged perspective view of a typical monitor unit of the invention with the distance monitor and remote alarm connected;

FIG. 4, an exploded perspective view of the monitor unit of FIG. 3, with the distance monitor and the remote alarm separated and showing connections between the pad, monitor unit, and a key chain;

FIG. 5, a schematic representation of the monitor unit of FIGS. 3 and 4, and showing the operation thereof; and

FIG. 6, a view like that of FIG. 5, but showing another embodiment of the distance monitor

### DETAILED DESCRIPTION

Referring now the Drawing

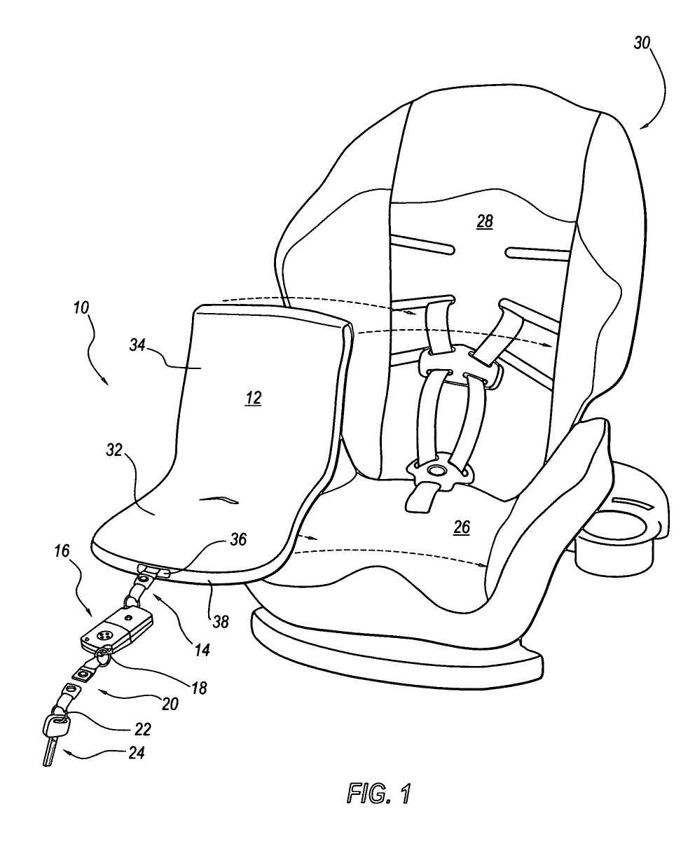

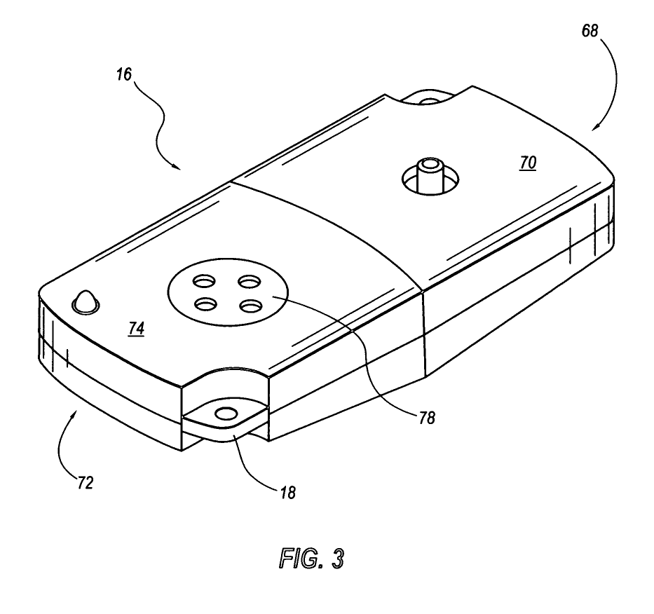

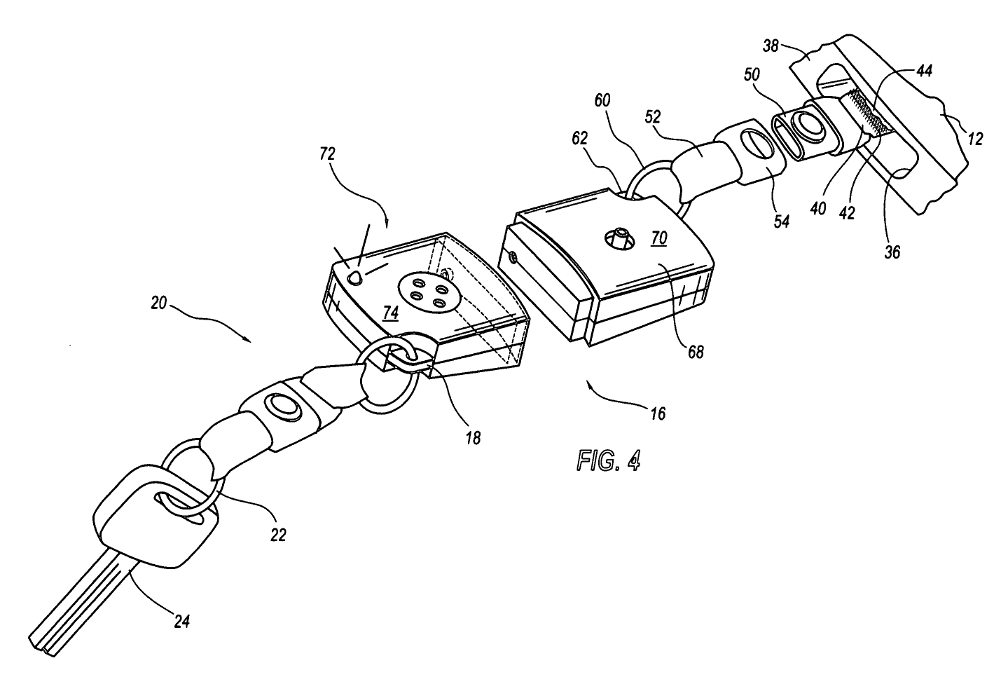

In the illustrated preferred embodiment, shown in FIGS. 1-5, the endangered child warning system is shown generally at 10.

The endangered child warning system 10 includes a pad 12. A quick connect coupler 14 secures a monitor unit 16 to the pad 12. The monitor unit 16 has a connector tab 18 which another quick connect coupler 20 is secured. A ring 22 secures the quick connect coupler 20 to an automobile key 24.

As shown in FIG. 1, pad 12 is made of a flexible, soft material, such as a soft fabric banket material and is adapted to be shaped to sit on the seat 26 and rest against the back 28 of a child safety car seat, shown generally 30. It will be apparent that the pad 12, because of the nature of the material from which it is made, and the flexibility of the pad can be as well used with other child restraint systems. For example, the pad 12 can be laid beneath a child in a bassinet, or child bed (not shown) that is also securely affixed to a vehicle. Similarly pad 12 can be placed beneath a behind a child in a stroller (not shown).

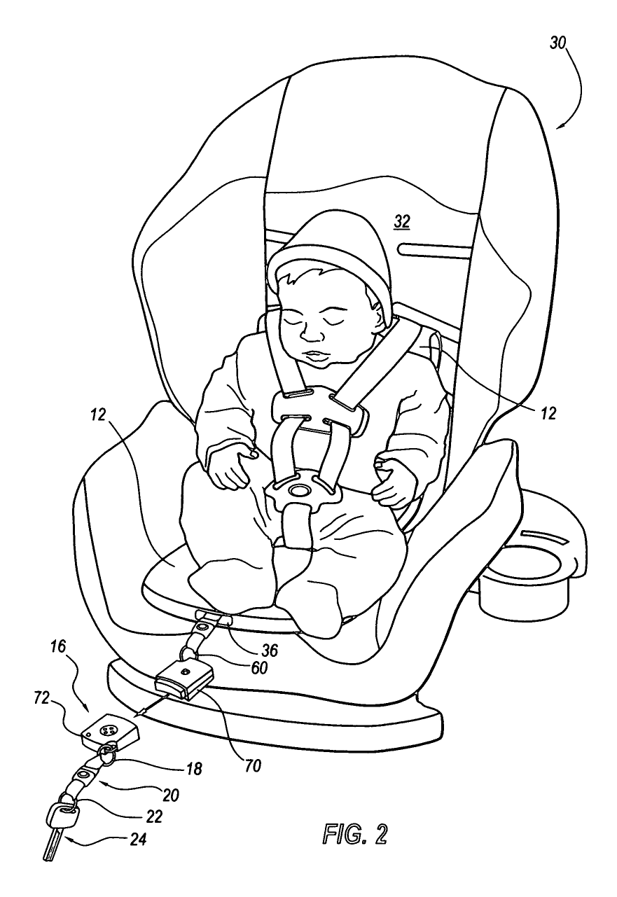

As seen in FIG. 2, when used with a child's safety seat 30, the pad 12 has a portion 32 positioned beneath the baby and a portion 34 that may extend upwardly behind the baby. The quick connect coupler 14 extends from the portion 32 beneath the baby and from a pocket 36 formed in leading edge 38 of the pad.

Coupler 14 includes a strap end 40 with hook connectors 42 on opposite faces thereof. Strap end 40 is secured to pad 12 by inserting the strap end into pocket 36. Top and bottom surfaces of pocket 36 have loop connectors 44 that engage and hold the hook connectors 42 when pressed against the strap end 40 of coupler 14 after the strap end is inserted into pocket 36.

Strap end 40 of coupler 14 is connected to a receiver 50 of coupler 14 and an insert 52 has one end 54 adapted to be inserted into and coupled to receiver 50 in conventional manner.

A ring 60 passes through insert 52 and a tab 62 of the monitor unit 16 to secure the coupler 14 to the monitor unit

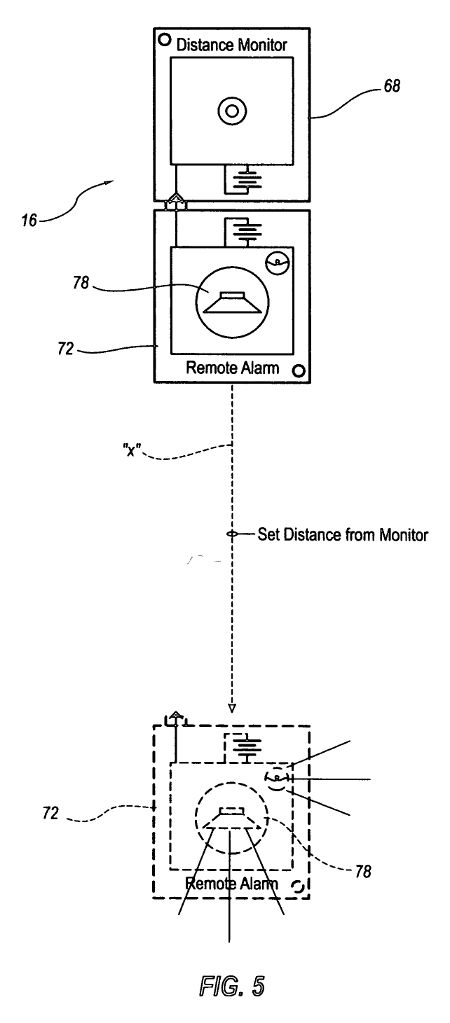

Commercially available monitor unit 16 includes a distance monitor 68 in a housing 70, and a remote alarm 72 having a housing 74. Distance monitor 68 plugs into remote alarm 72 and when the monitor and alarm are coupled together, no sound is emitted from the remote alarm. If, however, the alarm 72 is disconnected from the monitor and is moved a predetermined distance “x” (FIG. 5) away the monitor an audible signal unit 78 in the alarm 72 is activated, and a loud signal is generated.

It will be apparent that if the pad 12 is positioned beneath a child in the child car seat, the responsible person can easily connect the vehicle ignition and door key to the monitor unit 16 using the quick connect coupler 20 as the child is placed in the seat. The responsible person can then remove the remote alarm 72. Thereafter, if the responsible person moves from the vehicle while leaving the child in the car seat, and beyond the pre-set distance “x”, the remote alarm will sound to alert the responsible adult and other persons in the vicinity that the child is still in the vehicle. Alternatively, of course, the responsible person can attach the key to the remote alarm before moving away from the vehicle, while leaving the child in the vehicle and taking the key and remote alarm away from the vehicle.

Furthermore, if the car seat is moved, either in or out of the vehicle, beyond the “x” distance away from the responsible person holding the vehicle key and the remote alarm, the audio alarm will be activated to alert anyone within hearing distance. The audio alarm will continue to sound until the remote alarm is again plugged into the distance monitor.

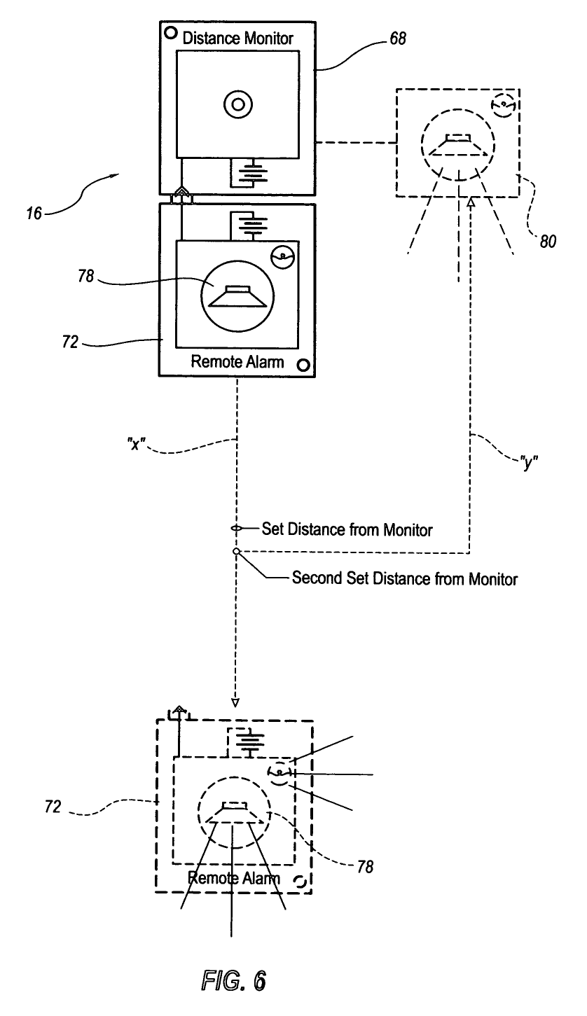

As shown in FIG. 6, the endangered child warning system may be modified by adding a second audio alarm 80 inside the housing 70. The second audio alarm 80 can be activated upon separation of the remote alarm 72 from the distance monitor 68 beyond the distance “x”, or can be set to sound when the distance “x” has been exceeded by a pre-set distance “y”. The sound audio alarm will then alert anyone within hearing of the presence of the baby.

Pad 12 is separated from monitor unit 16 by separating the hooks 42 on the strap end 40 and loops 44 on the inside of pocket 36 and pulling the strap end 40 from the pocket 36. The pad is then safely washed in a washing machine, or otherwise. The soft pad is thus easy to clean and can be kept sanitary for use with the child.

Although preferred forms of my invention have been herein disclosed, it is to be understood that the present disclosure is by way of example and that variations are possible without departing from the subject matter coming within the scope of the following claims, which subject matter I regard as my invention.

I claim:

1. An endangered child warning system comprising
a flat soft pad deformable to fit in the seat of a child car seat beneath a child placed in a car seat;
a distance monitor secured to said soft pad and projecting from said pad, and having a connector end;
a remote alarm having an audio alarm and means at one end thereof to removably receive said connector end of said distance monitor whereby when said means at one end of said remote alarm is received in said distance monitor, the audio alarm in said remote alarm is turned off and whereby separation of said remote alarm from said distance monitor for a pre-set distance will activate said audio alarm; and
a key chain for connecting a vehicle key, said key chain being connected to said remote alarm.

2. An endangered child warning system as in claim 1, wherein the key chain includes a quick connect coupler between means for attachment to a key and means connecting said key chain to said remote alarm.

3. An endangered child warning system as in claim 2, wherein the means for securing said distance monitor to said soft pad includes a quick connect coupler.

4. An endangered child warning system as in claim 1, wherein the means for securing said distance monitor to said soft pad includes
a pocket formed in a front edge of said pad;
insert means attached to said distance monitor to extend into said pocket; and
hook and loop fastener means fixed to said pocket and said insert means to releasably secure said insert means to said pad.

5. An endangered child warning system as in claim 2, wherein the means for securing said distance monitor to said soft pad includes
a pocket formed in a front edge of said pad;
insert means attached to said distance monitor to extend insertable into said pocket; and
hook and loop fastener means fixed to said pocket and said insert means to releasably secure said insert means to said pad.

6. An endangered child warning system as in claim 1, wherein
said distance monitor includes a second audio alarm to be activated upon separation of said distance monitor and said remote alarm by at least said pre-set distance.

7. An endangered child warning system as in claim 4, wherein
said distance monitor includes a second audio alarm to be activated upon separation of said distance monitor and said remote alarm by at least said pre-set distance.
